(19) United States
(12) Patent Application Publication
(10) Pub. No.: US 2024/0256922 A1
(43) Pub. Date: Aug. 1, 2024

(54) FAST ADAPTATION FOR DEEP LEARNING APPLICATION THROUGH BACKPROPAGATION

(71) Applicant: Microsoft Technology Licensing, LLC, Redmond, WA (US)

(72) Inventors: Ganesh ANANTHANARAYANAN, Sammamish, WA (US); Yuanchao SHU, Kirkland, WA (US)

(73) Assignee: Microsoft Technology Licensing, LLC, Redmond, WA (US)

(21) Appl. No.: 18/104,073

(22) Filed: Jan. 31, 2023

(51) Int. Cl. G06N 5/04; G16Y 20/10; G16Y 30/00

(52) U.S. Cl. CPC G06N 5/04; G16Y 20/10; G16Y 30/00

(57) ABSTRACT

Systems and methods are provided for dynamically adapting configuration setting associated with capturing content as input data for inferencing in the Multi-Access Edge Computing in a 5G telecommunication network. The inferencing is based on a use of a deep neural network. In particular, the method includes determining a gradient of a change in inference data over a change in configuration setting for capturing input data (the inference-configuration gradient). The method further updates the configuration setting based on the gradient of a change in inference data over a change in the configuration setting. The inference-configuration gradient is based on a combination of an input-configuration gradient and an inference-input gradient. The input-configuration gradient indicates a change in input data as the configuration setting value changes. The inference-input gradient indicates, as a saliency of the deep neural network, a change in inference result of the input data as the input data changes.

### BACKGROUND

With the advent of 5G, Multi-access Edge Computing (MEC), data analytics pipelines have become important to improve accuracy of capturing sensor data by sensor devices placed in the field. In MEC, there is a hierarchy of devices and servers. The hierarchy of devices and servers may collectively form a data analytic pipeline for an artificial intelligence (AI) application to interpret and respond to the input data. For instance, Internet-of-Things (IoT) devices, e.g., cameras of personal or commercial security systems, municipal traffic cameras, dashboard cameras on vehicles, and the like, capture and transmit stream data (e.g., video data) to cell towers. The cell towers relay the stream data to edge servers in on-premises (i.e., “on-prem”) edges as uplink data traffic. Some of the IoT devices perform pre-processing of input data and/or process as part of the inferencing of the input data. The on-premises edge servers may generate inferences based on the stream data and transmit the inference data to network servers at network edges of a cloud infrastructure. The network servers may also generate inference data and transmit the data to cloud servers for further processing. In aspects, a combination of the IoT devices and the servers in the MEC hierarchy may form a data analytics pipeline. The data analytics pipeline may include a series of operations at various locations in the pipeline for analyzing data, recognizing objects in the data, and making decisions through various stages of generating inference data.

Thus, while conventional configuration management techniques have limited effectiveness in timely adjusting the configuration setting, a need arises for determining and dynamically updating the configuration setting to adapt to sudden changes in content in a timely manner while minimizing an overhead use of computing resources. It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to dynamically determining and updating the configuration setting associated with capturing input data for inferencing in a data analytics pipeline under multi-access edge computing (MEC) systems. As noted above, the MEC involves a hierarchy of servers and data centers with a spectrum of varying levels of resource availability and geographic localities. An IoT device (e.g., a video camera, a sensing device, and the like) captures data according to the configuration setting. The IoT device, and/or an on-premises edge server, performs data analytics (e.g., video analytics, such as inference determination, on the video stream data) using a machine learning model (e.g., a deep neural network). The present disclosure dynamically updates the configuration setting based on a change or a gradient associated with a result of the inference determination and changes in the configuration setting.

The disclosed technology relates to techniques for dynamically determining values of the configuration setting associated with capturing content by a sensing device and updating the configuration setting data to continuously maintain and improve accuracy of inferring captured input data. Inferencing of the captured input data may include use of a deep neural network as part of a data processing pipeline. The disclosed technology determines an inference-configuration gradient to further determine and update the configuration setting for capturing subsequent data.

In aspects, the term “gradient” may refer to a ratio of a difference between values of a parameter type over a difference between values of another parameter type. The term “gradient” may further refer to a derivative of a parameter type over another parameter type. An inference-configuration gradient may refer to a derivative of inference data over the configuration setting. That is, the inference-configuration gradient describes how much a small change in the current value of each parameter type of the configuration setting for inputting data alters the confidence scores associated with inferencing from below (or above) the confidence threshold to above (or below). An input-inference gradient may refer to a derivative of input data over inference data. The disclosure uses the inference-configuration gradient data to determine a parameter type and a value of the parameter type to update the configuration setting. The IoT device captures a subsequent input data according to the updated configuration setting, thereby improving, or at least maintaining a level of accuracy in inferencing the input data stream.

In aspects, the term “data analytics pipeline” may refer to a series of devices and servers for capturing and analyzing data. For instance, stream data (e.g., video stream data) may be captured by an IoT device (e.g., a video camera) and transmitted via a cell tower to a hierarchy of servers within an MEC system having varying resource constraints for processing the stream data. The term “on-premises edge” may refer to a datacenter at a remote location at the far-edge of a private cloud, which may be in proximity to one or more cell towers. The RAN, in combination with a core network of a cloud service provider, represents a backbone network for mobile wireless telecommunications. For example, cell towers may receive and transmit radio signals to communicate with IoT devices (e.g., video cameras) over a RAN (e.g., 5G). Various service applications may perform different functions, such as network monitoring or video streaming, and may be responsible for evaluating data associated with the data traffic. For instance, a service application (e.g., an AI application) may perform data analytics, such as object recognition (e.g., object counting, facial recognition, or human recognition) on a video stream.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 illustrates an overview of an example system for reducing stream data based on a data streaming protocol in a data analytics pipeline across an MEC hierarchy in accordance with aspects of the present disclosure.

FIG. 2 illustrates an example system for dynamically updating the configuration setting for capturing input data in accordance with aspects of the present disclosure.

FIG. 3 illustrates an example device for dynamically updating the configuration setting for capturing input data in accordance with aspects of the present disclosure.

FIG. 4 illustrates an example of computing gradient values in accordance with aspects of the present disclosure.

FIG. 5 illustrates an example of data associated with dynamically adapting the configuration setting to capture input data in accordance with aspects of the present disclosure.

FIG. 6 illustrates an example of a method for dynamically updating the configuration setting to capture input data in accordance with aspects of the present disclosure.

FIG. 7 is a block diagram illustrating an example of physical components of a computing device with which aspects of the disclosure may be practiced.

FIG. 8 is a simplified block diagram of a computing device with which aspects of the present disclosure may be practiced.

### DETAILED DESCRIPTION

Various aspects of the disclosure are described more fully below with reference to the accompanying drawings, which from a part hereof, and which show specific example aspects. However, different aspects of the disclosure may be implemented in many different ways and should not be construed as limited to the aspects set forth herein; rather, these aspects are provided so that this disclosure will be thorough and complete and will fully convey the scope of the aspects to those skilled in the art. Practicing aspects may be as methods, systems, or devices. Accordingly, aspects may take the form of a hardware implementation, an entirely software implementation or an implementation combining software and hardware aspects. The following detailed description is, therefore, not to be taken in a limiting sense.

Use of artificial intelligence in inference applications has become increasingly popular in automatically analyzing sensor data. The inference application performs inferencing upon various data streams captured by sensing devices. For example, some systems use a deep neural network (DNN) to analyze video content that depicts automobile traffic, monitors speeds of vehicles, and identifies traffic congestions on streets. The devices are connected to networks as IoT (“internet of things) devices as sensing devices (e.g., video cameras, infrared cameras, Light Detection and Ranging (e.g., LiDAR) sensors, heat sensors, and the like).

IoT devices and associated systems may capture input data and determine features of the data by processing data in a data analytic pipeline. Devices and servers in the data analytic pipeline may process the data in series or in parallel to generate inferences (e.g., object recognition), and execute actions based on the inferences. For example, a data analytics performed on video stream data may include recognizing regions of interest, recognizing types of objects (e.g., a face, an apple, an automobile, etc.), generating inference data based on the regions of interest and/or the object types (e.g., an identity of a person), and processing the inference data to determine an action (e.g., making a phone call to the person). Accordingly, early stages of the data analytics pipeline may include processing video frames, whereas later stages may not. Some of the inferencing processes may take place in the IoT devices, while other parts of the inferencing processes may be processed by devices and servers that are higher in the MEC hierarchy.

Capturing input data based on the configuration setting that matches with a focus of inferencing improves a level of accuracy of the inferencing data. For example, capturing a frame of video data at a high image resolution enables an increase in a level of accuracy of inferencing the captured video data when the inferencing needs to distinguish between objects based on differences in details of the objects in the frame of video data. Furthermore, updating values of the configuration setting in a timely manner becomes important to maintain and improve the level of accuracy in inferencing when content of a frame of video substantially changes. For example, a brightness setting for capturing image data needs to be quickly adjusted when content of video data captured by a dashcam of a vehicle substantially changes as the vehicle exits from a tunnel to a brighter location. Some traditional system may automatically adjust configuration setting associated with sensitivity to brightness based on captured images in response to a change in sensed brightness.

In some aspects, traditional systems profile different configuration settings and switch from using one profile to another to maintain a level of accuracy in inferencing. The traditional systems select a profile, which includes configuration setting data that yields high inference accuracy without exceeding a predetermined resource budget. However, each profiling needs to be determining based on executing an additional inferencing to analyze multiple configurations (some are expensive in terms of resource usage). Thus, when resources that are available by Graphical Processing Unit (GPU) are limited, the traditional system updates profiles less frequently. The reduced frequency in updating profiles often results in using outdated configurations when content of captured data changes and the optimal configuration has drifted away. Additionally, or alternatively, the traditional system may significantly prune the search space for updating the profiles, resulting in generating profiles with suboptimal configurations.

Some other traditional systems adapt the configuration setting based on recent DNN outputs (including intermediate outputs). Though no extra inference is needed to obtain the DNN outputs, this approach tends to adapt to changes in captured content slowly. Each DNN output reveals limited information regarding the highly complex relationship between the configurations and DNN inference output and a level of accuracy in inferencing, The limited information from the DNN output is often caused by the complexity of the DNN and the preprocessing modules being used before executing the DNN (e.g., processing video codecs). For example, a traditional system for video object detection adjusts the video encoding quality by collecting the regions of interests from the DNN that may contain objects of interest. The traditional system encodes these regions in higher encoding quality on subsequent video frames to be captured. Accordingly, the objects inside these regions are much more likely to be detected.

An issue of misalignment of regions of interests occurs when the traditional system updates the configuration setting based on output from the inferencing by the DNN. When misalignment occurs, the object detection DNN may fail to detect some objects and thus, the traditional system needs to further adjust the corresponding regions. As the regions generated by the DNN may not be exactly aligned with the region that actually contains the objects, the object detection DNN may fail to detect some objects and thus, the traditional system needs to further adjust the corresponding regions.

Moreover, the traditional approach of using inference data output from the DNN is often designed for updating specific types of parameters in the configuration setting. For example, the traditional system for video object detection extracts the regions that may contain objects and encodes them into a higher encoding quality by updating values of parameters associated with encoding quality and a region selection in the configuration setting. However, such information about the video containing objects may be less useful in other types of parameters in the configuration setting. For example, different types of parameters for the configuration setting are used in discarding some frames of video without degrading the inference accuracy. A process for deciding which frames to discard needs to be based on the knowledge of whether the inference results of the discarded frames are similar to that of the reserved/retained frames.

The disclosed technology addresses the issue of serving a wide range of parameter types of configuration settings (e.g., knobs) associated with the IoT device. The disclosure further enables AI applications to quickly adapt to and maintain the optimal configuration setting when there is a large number of types in configuration settings, without causing a substantial increase in use of computing resources for inferencing data. The disclosed technology enables adapting to the optimal configuration by assigning values to various parameter types of the configuration setting in a way to increase a use of resources associated with the configuration setting with a high inference-configuration gradient. The disclosure further reduces a use of resources associated with parameter types of the configuration setting with a low inference-configuration gradient. This way, the dynamic adaptation improves accuracy by using more resources associated with one configuration setting while using less resources associated with some other configuration setting without reducing the accuracy.

In aspects, the disclosed technology decouples the calculation of the inference-configuration gradient (i.e., how changing the configuration setting alters the output of inferencing) into 1) how changing the configuration setting alters the input data for inferencing, and 2) how changing the input data for inferencing alters the inference (i.e., an output of DNN). The former may be calculated on a parameter-by-parameter basis in the configuration setting without a need to perform inferencing by using a DNN. The latter may be determined via backpropagation of the DNN using GPU.

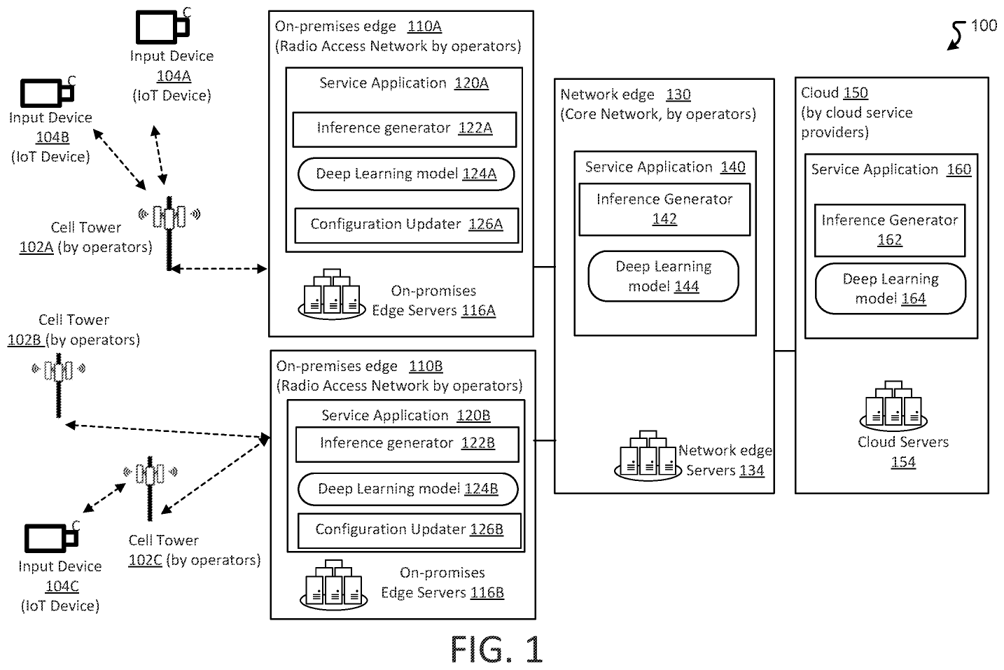

FIG. 1 illustrates an overview of an example system 100 for identifying techniques for reducing stream data transmitted across edge hierarchies under multi-access edge computing in accordance with the aspects of the present disclosure. Cell towers 102A-C transmit and receive wireless communications with IoT devices (e.g., video cameras, health monitors, watches, appliances, etc.) over a telecommunications network. Input devices 104A-C represent examples of IoT devices (e.g., video cameras) communicating with the cell towers 102A-C in the field. In aspects, the input devices 104A-C are capable of capturing video images, processing the video images to reduce data volume according to a data streaming protocol, and transmitting the reduced data over a wireless network (e.g., the 5G cellular wireless network) to one or more of the cell towers 102A-C. For example, respective input devices 104A-C may capture scenes for video surveillance, such as traffic surveillance or security surveillance. The example system 100 further includes on-premises edges 110A-B (including on-premises edge servers 116A-B), a network edge 130 (including core network servers), and a cloud 150 (including cloud servers responsible for providing cloud services). In aspects, the example system 100 corresponds to a cloud RAN infrastructure for a mobile wireless telecommunication network.

In aspects, the input devices 104A-C may filter captured video data as a preprocessing of input data stream according to the configuration setting. In some other aspects, the input devices 104A-C may recognize objects in the captured video data using a model. The input devices 104A-C may include an accelerator (e.g., a GPU) to process the captured video stream data. The input devices 104A-C may identify regions of interest and track moving objects (e.g., cars) in captured video frames. The input devices 104A-C may further determine types and numbers of objects identified in the video frames. In aspects, the data that describes types and numbers of objects may be in a textual format (e.g., a format using an extensible Markup Language). In some other aspects, the data may include one or more portions of a video image of the captured video frames. The one or more portions of the video image may correspond to regions of interest for further processing in the data analytic pipeline. Techniques for processing the video stream data may depend on computing and memory resources available in the respective input devices 104A-C. The input devices 104A-C may transmit the generated inference data as reduced stream data in a format of a data streaming protocol. The transmitted data may be processed further in the data analytics pipeline at on-premises edges 110A-B, the network edge 130, and/or the cloud 150.

As illustrated, the on-premises edges 110A-B are datacenters that are part of the cloud RAN. In aspects, the on-premises edges 110A-B enable cloud integration with a radio access network (RAN). The on-premises edges 110A-B include on-premises edge servers 116A-B, which process incoming data traffic and outgoing data traffic. The on-premises edge servers 116A-B may execute service applications 120A-B. In aspects, the on-premises edges 110A-B are generally geographically remote from the datacenters associated with the core network and cloud services. The remote site is in geographic proximity to respective cell towers. For example, the proximity may be within a few kilometers. As illustrated, the on-premises edge 110A is in proximity to the cell tower 102A, and the on-premises edge 110B is in proximity to the cell towers 102B-C. In aspects, the inference generator 122A and the inference generator 122B respectively generate inferences based on applying a machine learning model (e.g., a deep learning model 124A and a deep learning model 124B (e.g., a deep neural network)) to input data streams (e.g., video streams) captured by the IoT devices (e.g., input devices 104A-C). In aspects, the deep learning models 124A-B represent pre-trained models. The inference generators 122A-B transmit the inference data to an upstream server (e.g., the network edge servers 134 of the network edge 130).

In aspects, configuration updaters 126A-B determine and update the configuration setting associated with the respective input devices 104A-C. Examples of types of configuration settings may include, but are not limited to, image resolution, quantization parameter, video bitrate, frame rate, frame filtering thresholds, fine-grained video compression, and fine-grained feature compression. In aspects, higher values of the configuration setting translate into allocating and consuming more computing resources, which results in attaining a higher level of accuracy in inference data. For example, increasing a data resolution (e.g., an image resolution) consumes more computing resources in memory and processing image data, and further improves accuracy of inferencing the input data.

The configuration updaters 126A-B may determine an inference-configuration gradient based on a combination of an input-configuration gradient and an inference-input gradient. In aspects, the configuration updaters 126A-B determine the input-configuration gradient based on a sequence of data streams, and the configuration setting data associated with the respective input devices 104A-C is received by the on-premises edge 110A. The input-configuration gradient data indicates how a change in the configuration setting alters content of input data. Furthermore, the configuration updaters 126A-B generate the inference-input gradient data based on backpropagation as performed by the deep learning models 124A-B.

In aspects, an on-premises edge 110A may aggregate data it receives from the input devices 104A-B and generate inference data based on the aggregated data from the respective input devices 104A-B for transmission to the network edge 130. For example, the input devices 104A-B may capture video of a same location from different perspectives (e.g., a scene of a street from two opposite directions). The on-premises edge 110A may aggregate the two streams of data to generate inference data.

In further aspects, as datacenters become closer to the cloud 150, server resources (including processing units and memory) become more robust and powerful. As an example, servers 154 may be more powerful than network edge servers 134, which may be more powerful than the on-premises edge servers 116A-B.

In aspects, the network edge 130 is at a regional datacenter of a private cloud service. For example, the regional datacenter may be about tens of kilometers from the cell towers 102A-C. The network edge 130 includes service application 140 that when executed, performs data analytics. For example, the service application 140 includes video ML model or inference generator 142, which performs and manages video analytics using machine learning technologies, such as neural networks, to train analytics models. The network edge 130 may comprise memory resources that are more expansive than the memory resources available to the on-premises edge servers 116A-B of the on-premises edges 110A-B.

The cloud 150 (service) includes cloud servers for performing resource-intensive, non-real-time service operations. In aspects, one or more servers in the cloud 150 may be at a central location in a cloud RAN infrastructure. In this case, the central locations may be hundreds of kilometers from the cell towers 102A-C. In aspects, the cloud 150 includes service application 160 for performing data analytics. The service application 160 may perform similar processing tasks as a service application 140 in the network edge 130.

In aspects, the on-premises edges 110A-B, which are closer to the cell towers 102A-C and to the input devices 104A-C(or IoT devices) than the cloud 150, may provide real-time processing. In contrast, the cloud 150, which is the furthest from the cell towers 102A-C and input devices 104A-C in the cloud RAN infrastructure, may provide processing in a non-real-time manner.

The service applications 120A-B include program instructions for processing data according to predetermined data analytics scenarios on the on-premises edge servers 116A-B. The predetermined analytics may include, for example, inference generators 122A-B for generating inferences based on captured data. In aspects, the inference generators 122A-B perform video analytics and generate inference data by extracting and identifying objects from video stream data according to a trained model. For example, the inference generators 122A-B may rely on a plurality of trained models to identify different types of objects (e.g., trees, animals, people, automobiles, etc.), to generate a count of objects (e.g., the number of people in a video frame), and/or identify a particular object (e.g., a particular person based on facial recognition). In aspects, each model may be trained to identify a different type of object.

The incoming video stream may include background data and object data, which IoT devices (e.g., the input devices 104A-C) captured and transmitted to the cell towers 102A-C. For example, the service applications 120A-B may analyze the video stream and extract portions of the video stream as regions of interest, which regions of interest may comprise object data as opposed to background data. Once extracted, the regions of interest may be evaluated to recognize objects (e.g., the face of a person), as described above, or the service applications 120A-B may transmit the extracted regions of interest (rather than the full video stream) to the cloud for further processing (e.g., to identify a person by performing facial recognition on the face of the person). In aspects, the edge servers 116 include computing and memory resources that are limited, while the network edge servers 134 at the network edge 130 include resources that are sufficiently robust to perform facial recognition on the video stream to identify a name of a person.

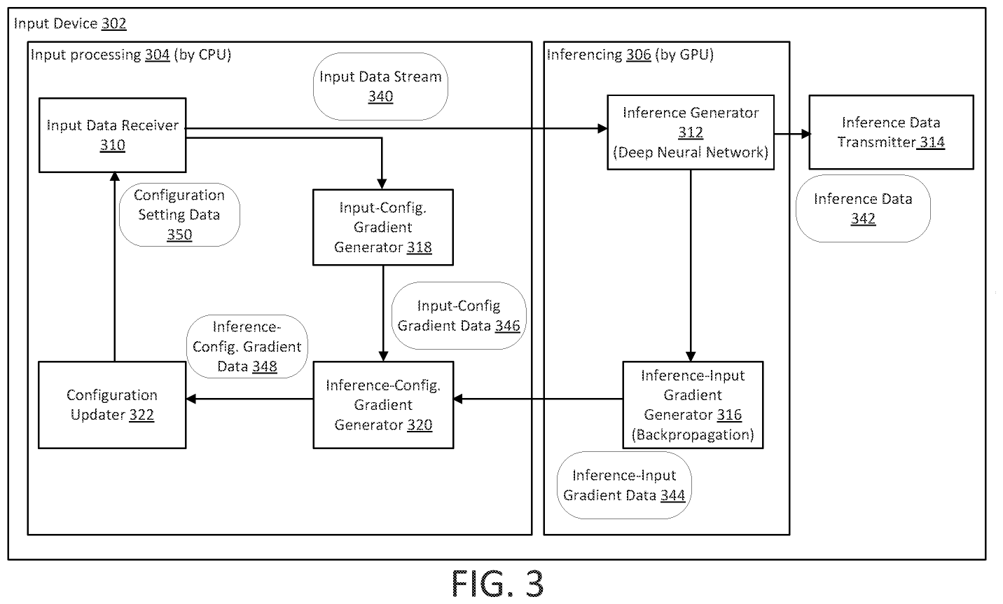

In some other aspects, the respective input devices 104A-C may incorporate the service applications 120A-B. Accordingly, the respective input devices 104A-C may include the inference generators 122A-B, the deep learning models 124A-B, and the configuration updaters 126A-B. For example, the input device 104A may include a central processing unit (CPU) to process capturing of input data (e.g., video data) and pre-processing of the input data for the deep learning model 124A. The input device 104A may further include a graphical processing unit (GPU) to execute the inference generator 122A using the deep learning model 124A. (See also, FIG. 3.)

As will be appreciated, the various methods, devices, applications, features, etc., described with respect to FIG. 1 are not intended to limit the system 100 being performed by the particular applications and features described. Accordingly, additional controller configurations may be used to practice the methods and systems herein and/or features and applications described may be excluded without departing from the methods and systems disclosed herein.

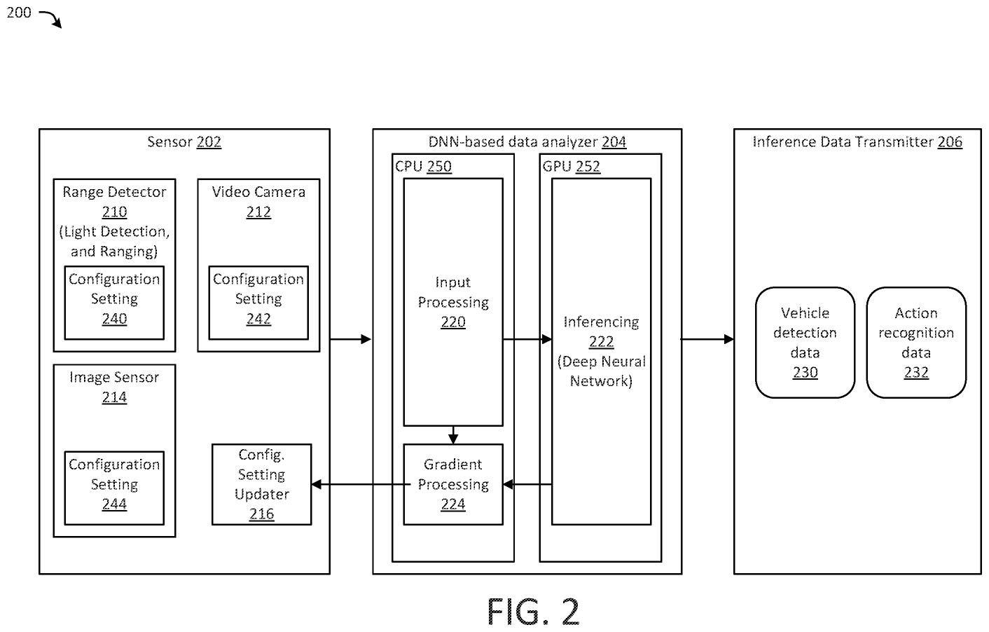

FIG. 2 illustrates an example system for dynamically updating the configuration setting for capturing input data in accordance with aspects of the present disclosure. The system 200 includes sensor 202, a DNN-based data analyzer 204, and inference data transmitter 206. In some other aspects, the system 200 corresponds to a combination of the input device 104A and the on-premises edge 110A. The sensor 202 (e.g., the input device 104A as shown in FIG. 1) captures images and transmits input stream data (e.g., a sensor stream data, a video stream data, and the like) to the DNN-based data analyzer 204 (e.g., the on-premises edge 110A via a cell tower (e.g., the cell tower 102A as shown in FIG. 1). In some other aspects, the system 200 corresponds to the input device 104A when the input device 104A includes the service application 120A.

The sensor 202 includes one or more type of sensors. For example, range detector 210 detects a range or distance through light detection and/or ranging. The range detector 210 includes configuration setting 240 for setting various parameter values for detecting a range. Video camera 212 captures a video stream data as input using configuration setting 242. Image sensor 214 captures image data as input using configuration setting 244. The sensor 202 includes configuration setting updater 216. The configuration setting updater 216 updates the configuration setting associated with respective sensors (e.g., the configuration setting 240 associated with the range detector 210, the configuration setting 242 associated with the video camera 212, the configuration setting 244 associated with the image sensor 214, and the like).

The DNN-based data analyzer 204 generates inference data based on input data using a trained deep neural network (DNN). In aspects, CPU 250 performs input processing 220 and gradient processing 224. GPU 252 performs inferencing 222 using the trained deep neural network (e.g., the deep learning model 124A as shown in FIG. 1). In aspects, the CPU 250 and the GPU 252 are distinct processors. The input processing 220 receives the captured data stream from the sensor 202 and generates input data for the inferencing 222 (the deep neural network). In aspects, the input data comprises a multi-dimensional vector that represents image data in pixels. Each dimension of the multi-dimensional vector corresponds to a pixel of the image data.

The gradient processing 224 generates a pair of an input-configuration gradient and an inference-input gradient based on a combination of the stream data, the configuration setting associated with the sensor 202 for capturing the data stream as input, and a result of inferencing 222 based on the stream data. Based on the pair of an input-configuration gradient and an inference-input gradient, the gradient processing 224 generates an inference-configuration gradient by multiplying values of the pair.

The inference-configuration gradient indicates how a change in the configuration setting alters the inference data. The input-configuration gradient indicates how a change in configuration setting alters the input data. The inference-input gradient indicates how a change in input data alters the inference. Given the inference-configuration gradient, the gradient processing 224 determines values to update one or more types of configuration settings associated with the sensor 202 for capturing a subsequent input in the stream data. The configuration setting updater 216 updates the respective configuration setting of the sensor 202.

In aspects, a value of inference may be based on a confidence value associated with the inference data. In some aspects, a change in inference may be based on a difference between the confidence value and a predetermined threshold value, thereby removing the need to process inferencing a plurality of times and reducing GPU resource consumption.

As will be appreciated, the various methods, devices, applications, features, etc., described with respect to FIG. 2 are not intended to limit the system 200 being performed by the particular applications and features described. Accordingly, additional controller configurations may be used to practice the methods and systems described herein, and/or features and applications described may be excluded without departing from the methods and systems disclosed herein.

FIG. 3 illustrates an example device for dynamically updating the configuration setting for capturing input data in accordance with aspects of the present disclosure. FIG. 3 illustrates an example of an input device 302. The input device 302 includes an input processing 304 (by CPU), inferencing 306 (GPU), and inference data transmitter 314. In aspects, the input processing 304 includes input data receiver 310 (or a data capturing device), inference-configuration gradient generator 320, and a configuration updater 322. The inferencing 306 (by GPU) includes inference generator 312 (deep neural network) and inference-input gradient generator 316 (backpropagation).

The input data receiver 310 captures input data stream 340. Examples of the input data stream 340 includes a video data stream, a range (e.g., a distance) data stream, and the like. The input-configuration gradient generator 318 generates input-configuration gradient data 346 based on the input data stream 340 and configuration setting data 350 used to capture the input data stream 340. In aspects, the configuration setting data 350 change over time as the configuration updater 322 updates the configuration setting data 350.

The inference generator 312 (deep neural network) generates inference data 342 based on the input data stream 340. In aspects, the inference data 342 may include a confidence value. The higher the confidence value, the more likely that the inference data 342 is more accurately inferred from the input data stream 340. The inference-input gradient generator 316 (backpropagation) generates an inference-input gradient data 344.

The inference-configuration gradient generator 320 receives the input-configuration gradient data 346 and the inference-input gradient data 344. By multiplying the input-configuration gradient data 346 and the inference-input gradient data 344, the inference-configuration gradient generator 320 generates inference-configuration gradient data 348.

The configuration updater 322 updates, based on the inference-configuration gradient data 348, values associated with types of configuration settings for capturing a subsequent data for the input data stream 340.

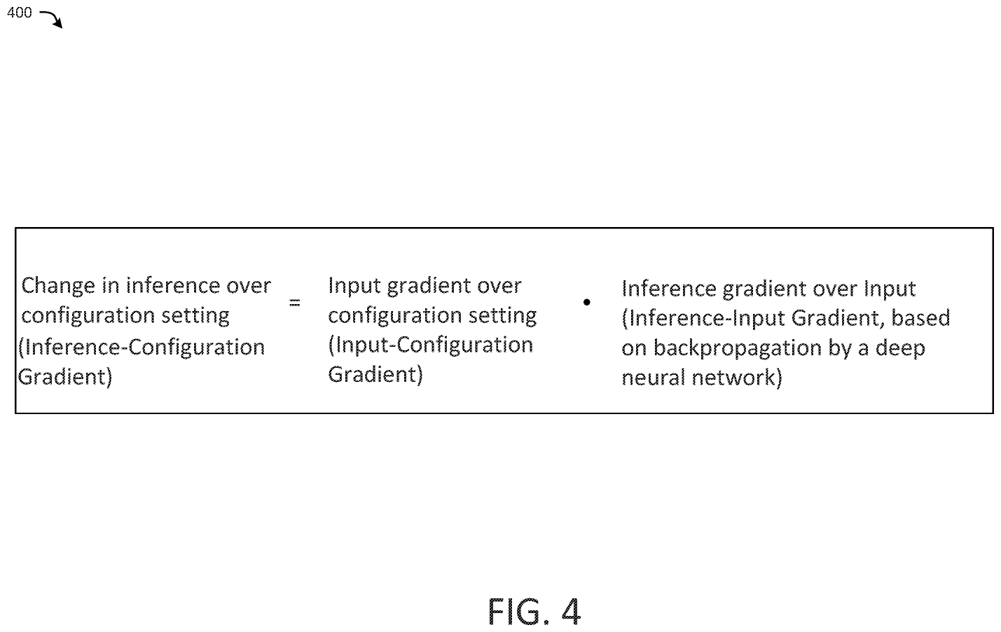

FIG. 4 illustrates an example of computing gradient values in accordance with aspects of the present disclosure. Hereinafter, the computing 400 shall be explained with reference to the systems, components, devices, modules, software, data structures, data characteristic representations, signaling diagrams, methods, etc., described in conjunction with FIGS. 1, 2, 3, 5, 6, 7, and 8.

In aspects, the computing 400 relates to computing a change in inference over the configuration setting as the inference-configuration gradient. Generating the inference-configuration gradient is based on the following equation:

$$Inference ‐ configuration gradient = Inference ‐ input gradient \times Input ‐ configuration gradient \qquad ( 1 )$$

Terms of computing gradient include partial derivatives.

$$\frac{\partial ( Inference )}{\partial ( Configuration Setting )} = \frac{\partial ( Input )}{( Configuration Setting )} \cdot \frac{\partial ( Inference )}{\partial ( Input )} \qquad ( 2 )$$

The inference-configuration gradient indicates a degree of change in an inference result based on a degree of change in value(s) of the configuration setting. The input-configuration gradient indicates a degree of change in input data based on a degree of change in value(s) of the configuration setting. For example, a change in the input data may be described in a difference in pixel values between two frames of video data in the input data stream.

The inference-input gradient indicates a degree of change in inference results based on a change in input data. In aspects, the inference-input gradient is the same as a result of backpropagation (i.e., saliency) by the deep neural network that performs inferencing of input data. The backpropagation may be performed by GPU, which is reserved for processing inferencing. In contrast, processing that relates to capturing input data and preprocessing input data may be performed by CPU. As such, determining the input-configuration gradient and the inference-configuration gradient consumes CPU resources, while determining the inference-input gradient based on backpropagation consumes GPU resources. The processing of the backpropagation results in a substantially constant computing overhead upon GPU resources without a need to perform inferencing of the same input data multiple times. GPU performs a combination of inferencing and the backpropagation based in input data by using the deep neural network.

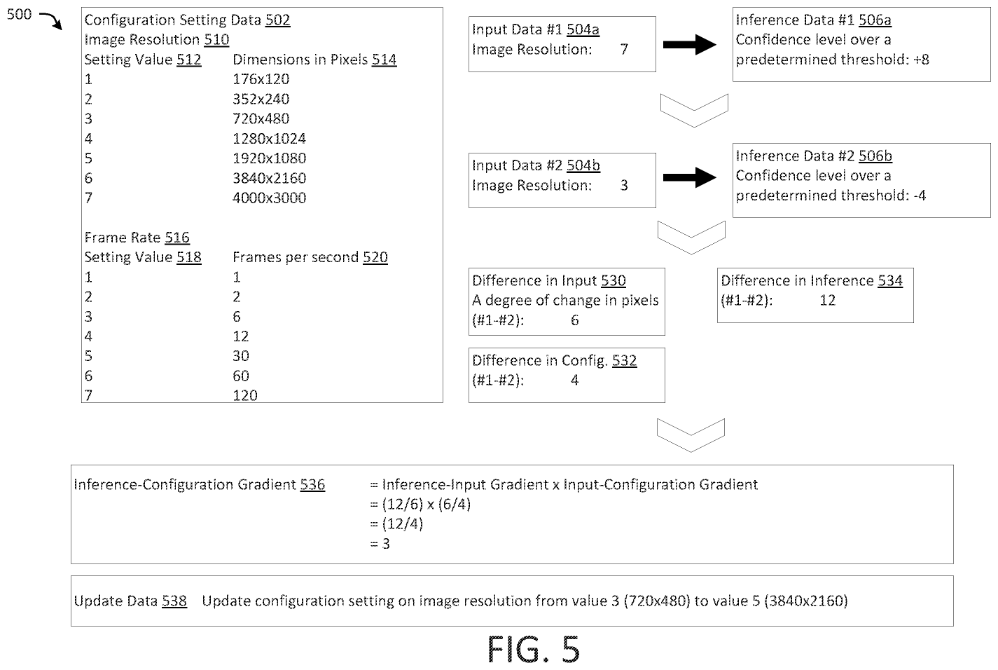

FIG. 5 illustrates an example of data associated with dynamically adapting the configuration setting to capture input data in accordance with aspects of the present disclosure. Hereinafter, the example data 500 shall be explained with reference to the systems, components, devices, modules, software, data structures, data characteristic representations, signaling diagrams, methods, etc., described in conjunction with FIGS. 1, 2, 3, 4, 6, 7, and 8.

The example data 500 includes configuration setting data 502, input data #1 504a, input data #2 504b, inference data #1 506a, inference data #2 506b, difference in input 530, difference in configuration setting data 532, difference in inference data 534, inference-configuration gradient 536, and update data 538.

In aspects, the configuration setting data 502 includes image resolution 510 and frame rate 516. The image resolution 510 includes seven distinct values, each associated with a distinct configuration setting on an image resolution. For example, setting value 512 of one (1) corresponds to dimensions in pixels 514 of 172 pixels horizontally and 120 pixels vertically. A value two corresponds to 352×240, value 3 corresponds to 720×480, value 4 corresponds to 1280×1024, value 5 corresponds to 1920×1080, value 6 corresponds to 3840×2160, and value 7 corresponds to 4000×3000. In aspects, the higher the setting value is, the higher the image resolution is, resulting in a higher accuracy in inferencing input image data. A video camera (e.g., the input device 104A (IoT device) as shown in FIG. 1) captures frames of image data as video data according to image resolution 510 as specified in the configuration setting.

The frame rate 516 indicates setting value 518 and a value of frames per second 520 used for capturing video data. For example, the setting value 518 of one (1) corresponds to one frame per second. Two corresponds to two frames per second. Three corresponds to six frames per second. Four corresponds to 12 frames per second. Five corresponds to 30 frames per second. Six corresponds to 60 frames per second. Seven corresponds to 120 frames per second, and the like. The video camera (e.g., the input device 104A (IoT device) as shown in FIG. 1) captures frames of image data as video data according to the frame rate 516 as specified in the configuration setting.

In aspects, the input data #1 504a represents a first image data as input using an image resolution value of seven (i.e., 4000×3000 pixels) as specified by the configuration setting data 502. Similarly, the input data #2 504b represents a second image data as input using an image resolution value of three (i.e., 720×480). According to the example, the image resolution of the input image data decreased by four.

Given the input data #1 504a, the disclosed technology performs inferencing and generates the inference data #1 506a by using a deep neural network (e.g., the deep learning model 124A as shown in FIG. 1, the inferencing 222 (the deep neural network) as shown in FIG. 2, and the inference generator 312 (the deep neural network) as shown in FIG. 3). In aspects, the inference data #1 506a indicates a confidence level over a predetermined threshold to be+8. The confidence level indicates a level of confidence of the inference data #1 506a accurately inferring the input data #1 504a. Similarly, the inference data #2 506b indicates a confidence level over the predetermined threshold to be −4. Thus, the level of confidence associated with inferencing the input data decreased by 12 over the two instances of input data. In examples, the decrease of confidence values may have been caused by a reduction in the image resolution upon the input video data.

A degree of changes in pixels between the input data #1 504a and the input data #2 504b is six. Difference in configuration setting data (i.e., the image resolution) is 4 (i.e., 7 minus 4). Difference in inference data 534 is 12 (8−(−4)=12). Accordingly, the inference-configuration gradient 536 may be determined by multiplying the inference-input gradient (12/6) and the input-configuration gradient (6/4). A resulting value of the inference-configuration gradient 536 is 3.

Based on the inference-configuration gradient 536 value of 3, the configuration setting of image resolution is increased by 3. Accordingly, the configuration setting of image resolution becomes 6 (i.e., 3840×2160) from 3 (720×480).

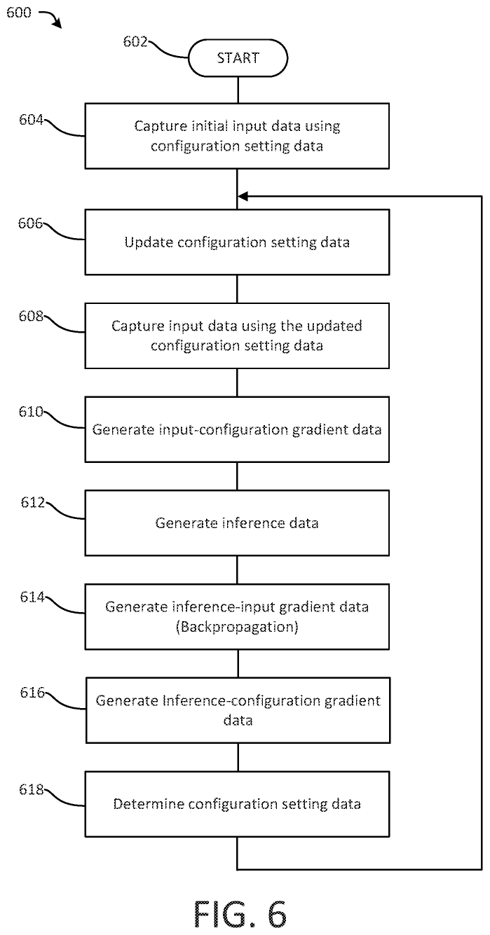

FIG. 6 is an example of a method for dynamically updating the configuration setting to capture input data in accordance with aspects of the present disclosure. A general order of the operations for the method 600 is shown in FIG. 6. Generally, the method 600 begins with start operation 602 and follows the determine configuration setting data operation 618 with the update configuration setting data operation 606. The method 600 may include more or fewer steps, or may arrange the order of the steps differently than those shown in FIG. 6. The method 600 can be executed as a set of computer-executable instructions executed by a computer system and encoded or stored on a computer readable medium. Further, the method 600 can be performed by gates or circuits associated with a processor, an ASIC, an FPGA, a SOC, or other hardware device. Hereinafter, the method 600 shall be explained with reference to the systems, components, devices, modules, software, data structures, data characteristic representations, signaling diagrams, methods, etc., described in conjunction with FIGS. 1, 2, 3, 4, 5, 7, and 8.

Following start operation 602, the method 600 begins with capture initial input data operation 604, which captures initial input data using the configuration setting data. In aspects, the configuration setting data for capturing the initial input data may be predetermined. The initial input data may be a frame of image data, video data, sensor data, and the like. The capture initial input data operation 604 may be performed by an input device (an IoT device; the input devices 104A-C as shown in FIG. 1). For example, the initial input data may represent an image data at a predetermined image resolution (e.g., the level 7 at 4000×3000 pixels as shown in FIG. 5).

Update configuration setting data operation 606 updates configuration setting data. In aspects, the configuration setting configures conditions for capturing input data. Types of the configuration setting include one or more of image resolution, frame rate, quantization parameter, video bitrate, frame filtering thresholds, fine-grained video compression, fine-grained feature compression, and the like. The configuration setting may include pre-processing of input data to generate input for inferencing. In some aspects, the configuration setting data may be based on a change of inference data associated with a previously captured input data. Additionally, or alternatively, the configuration setting data may be predetermined.

Capture input data operation 608 captures input data based on the updated configuration setting data of the input device. In aspects, the input data may be an image data that has been captured in a reduced image resolution based on the updated configuration setting data. (e.g., the level 3 at 720×480 pixels as shown in FIG. 5.)

Generate input-configuration gradient data operation 610 generates an input-configuration gradient data. In aspects, the input-configuration gradient data indicates a ratio of a change in input data over a change in the configuration setting data. For example, when a degree of a change in pixel content of the input image data based on a reduction of the image resolution is 6 and the change in the image resolution is 4, the input-configuration gradient data has a value of 1.5 (i.e., 6/4). In some aspects, the change in pixel content of two input image data may be expressed by comparing values of pixels in a two-dimensional coordinate associated with the two input image data.

In aspects, the configuration setting may include a plurality of types (e.g., image resolution, frame rate, bit rate, and the like). Determining input-configuration gradient data for each type of configuration setting may increase the encoding overhead proportional to a number of types. To reduce the overhead, the disclosed technology identifies those types of configuration settings that mainly trigger the input change on different, non-overlapping parts of input data. For example, some types of configuration settings impact a particular part (e.g., a left half image data) of input data, while other types impact distinct parts of input data. In aspects, the generate input-configuration gradient data operation 610 divides input data (e.g., a frame of image data) into distinct parts that correspond to the respective types of configuration settings and generate input-configuration gradient data associated with the respective parts of the input data in parallel.

Generate inference data operation 612 generates inference data associated with the input data. In aspects, a deep neural network may be used to perform inference. The deep neural network uses an encoded multi-dimensional vector of the captured data as input and predicts inferencing data as output. For example, the deep neural network may receive an encoded multi-dimensional vector that represents a frame of video data and predicts types of objects (e.g., a vehicle) and a number of the objects (e.g., a number of vehicles) in the frame of video data as inference data. In aspects, the deep neural network generates a confidence value associated with the inference data. The higher the confidence value is, the higher the accuracy is for inferring the input data. In aspects, the generate inference data operation 612 may be performed by a graphics processing unit (GPU) and/or a process that is distinct from CPU and is dedicated to processing the inferencing operations.

In examples, the inference data for the initial input data (or a previous input data) indicates a confidence level of 8 scores above a predetermined threshold. In contrast, the confidence level of the inference data for the current input data is 4 scores below the predetermined threshold. The decrease of 12 points in the confidence level of inference may have been caused by a reduction of image resolution for capturing the input data. In some other aspects, a change in content of input data (e.g., a change of scenery, including a change in content of frames of video data captured by a dashcam as an IoT device of a vehicle as the vehicle exits from inside a tunnel to outside the tunnel) may cause a change in configuration setting of the dashcam in response to the change in content.

Generate inference-input gradient data operation 614 generates inference-input gradient data (e.g., saliency) based on inferencing the input data. In aspects, backpropagation of the deep neural network generates the inference-input gradient data. The inference-input gradient data describes how a change of the input data alters a result of inferencing. In examples, the inference-input gradient data becomes 2 (i.e., 12/6) when a change in the inference data is 12 and a change of the input data is 6.

Performing the backpropagation operation may cause a high overhead in GPU computation overhead and a network bandwidth needed to stream saliency. To reduce the propagation cost, the generate inference-input gradient data operation 614 may be performed in periodic basis according to a predetermined period and reuse the generated data until the next time when the inference-input gradient data is generated. The periodic backpropagation operations may consume GPU resources in a predictable manner according to the periodic scheduling. For example, the predetermined period may be ten frames of video data stream. The reuse of saliency and the periodic generation of inference-input gradient data reduces the GPU overhead without sacrificing a degree of accuracy in inferencing.

In some aspects, the difference may be expressed by an absolute value, based on an assumption that a configuration setting has a “direction,” along which a change should only increase or keep a level of accuracy as an increasing level of resource consumption yields to an increasing level of accuracy (e.g., a higher image resolution of image data resulting in a higher level of accuracy in inferencing the image data). A value i corresponds to a type of configuration setting among a plurality of types in the configuration setting:

$$\frac{\partial ( Inferencing )}{\partial {( Configuration Setting )}_{i}} = \vert \frac{\partial ( Inferencing )}{\partial ( Input )} \vert \cdot \vert \frac{Δ ( Input )}{{Δ ( Configuration Setting )}_{i}} \vert \qquad ( 3 )$$

Generate inference-configuration gradient data operation 616 generates inference-configuration gradient data. In aspects, an inference-configuration gradient data indicates how a change in the configuration setting data alters inference data. In some aspects, the inference-configuration gradient data is based on a product of the inference-input gradient data and the input-configuration gradient data.

$$Inference ‐ input gradient = \frac{\partial ( Inferencing )}{\partial ( Input )} . \qquad ( 4 )$$

$$Input ‐ configuration gradient = \frac{\partial ( Input )}{\partial ( Configuration Setting )} . \qquad ( 5 )$$

$$Inference ‐ configuration gradient = \frac{\partial ( Inferencing )}{\partial ( Configuration Setting )} = \frac{\partial ( Input )}{\partial ( Configuration Setting )} \cdot \frac{\partial ( Inference )}{\partial ( Input )} \qquad ( 6 )$$

Determine configuration setting data operation 618 determines the configuration setting data based on the inference-configuration gradient data. In aspects, the inference-configuration gradient data indicates a degree of change (e.g., an increase of computing resource consumption, which also indicates a degree of improving accuracy in inferencing input data) for updating the configuration setting data. For example, the inference-configuration gradient data with a value 3 on an image resolution scale indicates that the configuration setting data associated with the image resolution needs to be increased by 3. Accordingly, the setting value of 3 (i.e., 720×480) increases to 6 (i.e., 3840×2160, as shown in FIG. 5.)

In aspects, the configuration setting may include a plurality of types, and more than an image resolution and/or a frame rate. The configuration setting data may be multidimensional. Accordingly, the inference-configuration gradient data may be multidimensional, representing a partial derivative of multi-dimensional data. By using the multi-dimensional gradient data, the disclosed technology identifies types of configuration setting data to increase values of specific types of configuration settings for improving accuracy and decrease values for other specific types of configuration settings without reducing accuracy.

In some aspects, bandwidth consumption may become an issue when the sensor (e.g., the input device 104A as shown in FIG. 1) and the deep neural network (e.g., the inference generator 122A with the deep learning model 124A as shown in FIG. 1) are connected via a network. Raw sensor data (i.e., raw input data stream) may need to be transmitted over the network to obtain a change of input data for the deep neural network before and after changing the configuration setting. To reduce the communication overhead, the inference-configuration gradient (i.e., backpropagation data or saliency) may be transmitted to the sensor to enable the sensor to determine the input-configuration gradient data within the sensor.

After the determine configuration setting data operation 618, the step of the method 600 proceeds to the update configuration setting data operation 606. The method 600 further proceeds to the capture input data operation 608 using the updated configuration setting data.

As should be appreciated, operations 602-618 are described for purposes of illustrating the present methods and systems and are not intended to limit the disclosure to a particular sequence of steps, e.g., steps may be performed in different order, additional steps may be performed, and disclosed steps may be excluded without departing from the present disclosure.

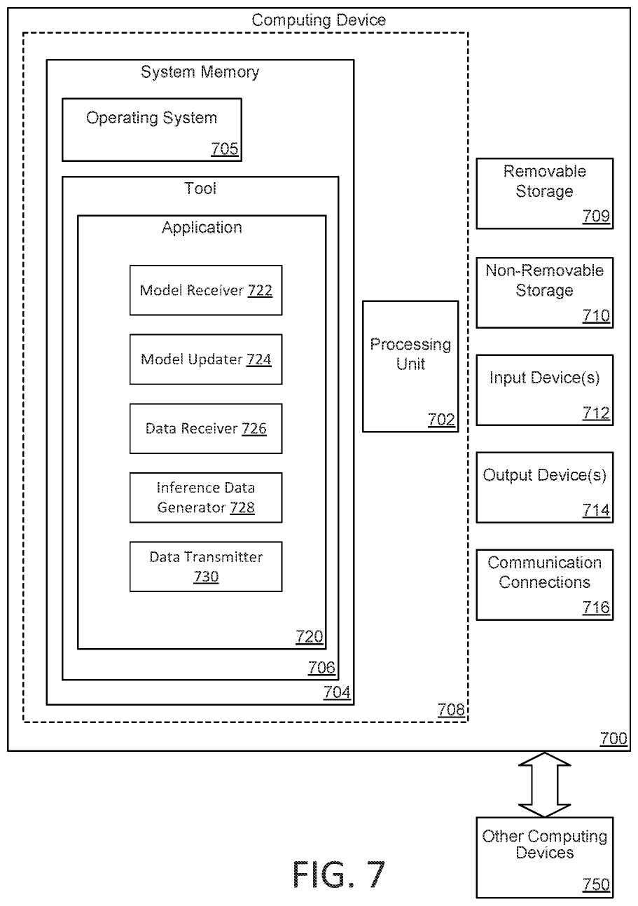

FIG. 7 is a block diagram illustrating physical components (e.g., hardware) of a computing device 700 with which aspects of the disclosure may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program tools 706 suitable for performing the various aspects disclosed herein as such. The operating system 705, for example, may be suitable for controlling the operation of the computing device 700. Furthermore, aspects of the disclosure may be practiced in conjunction with a graphics library, other operating systems, or any other application program, and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program tools and data files may be stored in the system memory 704. While executing on the at least one processing unit 702, the program tools 706 (e.g., an application 720) may perform processes including, but not limited to, the aspects, as described herein. The application 720 includes a model receiver 722, a model updater 724, a data receiver 726, an inference data generator 728, and a data transmitter 730 as described in more detail with regard to FIG. 2. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each, or many of the components illustrated in FIG. 7, may be integrated onto a single integrated circuit. Such an SOC device may include one or more processing units, graphics units, communications units, system virtualization units, and various application functionality, all of which are integrated (or “burned”) onto the chip substrate as a single integrated circuit. When operating via an SOC, the functionality, described herein, with respect to the capability of client to switch protocols, may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The computing device 700 may also have one or more input device(s) 712, such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of the communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristic set or changed in such a manner as to encode information in the signal. By way of example, and not limitation, communication media may include wired media such as a wired network or direct-wired connection, and wireless media such as acoustic, radio frequency (RF), infrared, and other wireless media.

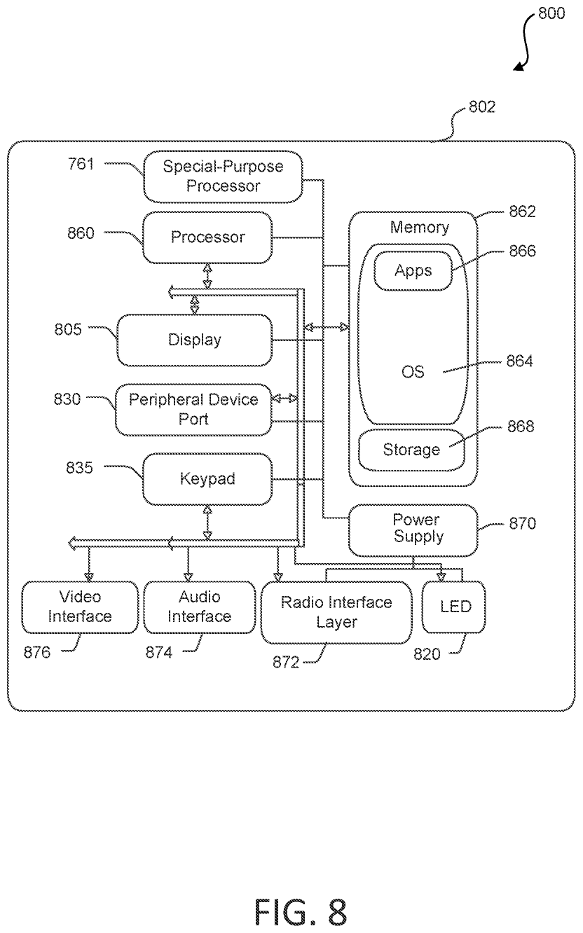

FIG. 8 illustrates a computing device 800, for example, a mobile telephone, a smart phone, a wearable computer (such as a smart watch), a tablet computer, a laptop computer, and the like, with which aspects of the disclosure may be practiced. In some aspects, the client utilized by a user (e.g., as an operator of servers in the on-premises edge 110A-B in FIG. 1) may be a computing device. With reference to FIG. 8, one aspect of a computing device 800 for implementing the aspects is illustrated. In a basic configuration, the computing device 800 is a handheld computer having both input elements and output elements. The computing device 800 typically includes a display 805 and one or more input buttons 810 that allow the user to enter information into the computing device 800. The display 805 of the computing device 800 may also function as an input device (e.g., a touch screen display). If included as an optional input element, a side input element 815 allows further user input. The side input element 815 may be a rotary switch, a button, or any other type of manual input element. In alternative aspects, the computing device 800 may incorporate more or less input elements. For example, the display 805 may not be a touch screen in some aspects. In yet another alternative aspect, the computing device 800 is a portable phone system, such as a cellular phone. The computing device 800 may also include an optional keypad 835. The optional keypad 835 may be a physical keypad or a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some aspects, the computing device 800 incorporates a vibration transducer for providing the user with tactile feedback. In yet another aspect, the computing device 800 incorporates input and/or output ports, such as an audio input (e.g., a microphone jack), an audio output (e.g., a headphone jack), and a video output (e.g., a HDMI port) for sending signals to, or receiving signals from, an external device.

FIG. 8 further illustrates aspects of the architecture of one aspect of a computing device, a server (e.g., the on-premises edge servers 116A-B, the network edge servers 134, and other servers as shown in FIG. 1), a mobile computing device, etc. That is, the computing device 800 can incorporate a system 802 (e.g., a system architecture) to implement some aspects. The system 802 can be implemented as a “smart phone” capable of running one or more applications (e.g., browser, e-mail, calendaring, contact managers, messaging clients, games, and media clients/players). In some aspects, the system 802 is integrated as a computing device, such as an integrated digital assistant (PDA) and wireless phone.

One or more application programs 866 may be loaded into the memory 862 and run on, or in association with, the operating system 864. Examples of the application programs include phone dialer programs, e-mail programs, information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail, or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the computing device 800 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 (e.g., LED) may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera 830 to record still images, video stream, and the like.

A computing device 800 implementing the system 802 may have additional features or functionality. For example, the computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the computing device 800 and stored via the system 802 may be stored locally on the computing device 800, as described above. Alternatively, the data may be stored on any number of storage media that may be accessed by the device via the radio interface layer 872 or via a wired connection between the computing device 800 and a separate computing device associated with the computing device 800(e.g., a server computer in a distributed computing network, such as the Internet). As should be appreciated, such data/information may be accessed via the computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

The description and illustration of one or more aspects provided in this application are not intended to limit or restrict the scope of the disclosure as claimed in any way. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

The present disclosure relates to determining and updating configuration setting for capturing input data in multi-access edge computing according to at least the examples provided in the sections below. A method for updating configuration setting is associated with capturing content using an Internet-of-Things (IoT) device of a plurality of IoT devices as at least a part of edge computing system. The method includes a first processor. The method comprises receiving, based on a configuration value associated with a configuration setting of the IoT device, input data; determining, by the first processor, a first gradient value, wherein the first gradient value represents a change of the input data from previously received input data based on a change in the configuration setting for capturing content using the IoT device; causing an edge server of the edge computing system to determine, using a neural network by a second processor, a second gradient value, wherein the second gradient value indicates a change of inference data based on the change of the input data, wherein the first processor and the second processor are distinct; updating, based at least on a combination of the first gradient value and the second gradient value, the configuration value associated with the configuration setting for adjusting an input operation of the IoT device, wherein the combination of the first gradient value and the second gradient value represents an anticipated change of the inference data over a change in the configuration value associated with the configuration setting of the IoT device, and wherein the updating results in improving inferencing of the input data by adjusting the configuration setting of the IoT device; and receiving, based on the updated configuration value using the IoT device, subsequent input data. The second processor includes a graphical processing unit associated with a data analytic pipeline of a Multi-access Edge Computing in a 5G telecommunication network, and wherein the second processor is distinct from the first processor. The first gradient value includes an input-configuration gradient, wherein the input-configuration gradient indicates a degree of change in the input data based on updating the configuration value. The second gradient value includes an inference-input gradient, wherein the inference-input gradient indicates a degree of change in confidence scores associated with inferencing the input data as the input data changes, and wherein the inference-input gradient is based on a saliency associated with the neural network. The combination of the first gradient value and the second gradient value represents an inference-configuration gradient, wherein the inference-configuration gradient indicates a degree of change in confidence scores associated with inferencing the input data based on updating the configuration value. The configuration value is associated with an image resolution for capturing content by the IoT device. The method further comprises receiving, based on the updated configuration value associated with the configuration setting for operating the IoT device, the subsequent input data; and updating, based at least on a combination including a subsequent change in configuration values and a subsequent change in inferencing the subsequent input data, the configuration value of the configuration setting for further operating the IoT device.

Another aspect of the technology relates to a system for capturing content using an Internet-of-Things (IoT) device, which includes a first processor, of a plurality of IoT devices in edge computing system. The system comprises a memory; and the first processor configured to execute a method comprising: receiving, based on a configuration value associated with a configuration setting of the IoT device, input data; determining, by the first processor, a first gradient value, wherein the first gradient value represents a change of the input data from previously received input data based on a change in the configuration setting for capturing content using the IoT device; causing the edge server to determine, using a neural network by a second processor, a second gradient value, wherein the second gradient value indicates a change of inference data based on the change in the input data, wherein the first processor and the second processor are distinct; updating, based at least on a combination of the first gradient value and the second gradient value, the configuration value associated with the configuration setting for adjusting an input operation of the IoT device, wherein the combination of the first gradient value and the second gradient value represents an anticipated change of the inference data over a change in the configuration value associated with the configuration setting of the IoT device, and wherein the updating results in improving inferencing of the input data by adjusting the configuration setting of the IoT device; and receiving, based on the updated configuration value using the IoT device, subsequent input data. The second processor includes a graphical processing unit associated with a data analytic pipeline of a Multi-access Edge Computing in a 5G telecommunication network, and wherein the second processor is distinct from the first processor. The first gradient value includes an input-configuration gradient, wherein the input-configuration gradient indicates a degree of change in the input data based on updating the configuration value. The second gradient value includes an inference-input gradient, wherein the inference-input gradient indicates a degree of change in confidence scores associated with inferencing the input data as the input data changes, and wherein the inference-input gradient is based on a saliency associated with the neural network. The combination of the first gradient value and the second gradient value represents an inference-configuration gradient, wherein the inference-configuration gradient indicates a degree of change in confidence scores associated with inferencing the input data based on updating the configuration value changes. The configuration value is associated with an image resolution for capturing content. The first processor further configured to execute a method comprising: receiving, based on the updated configuration value associated with the configuration setting for operating the IoT device, the subsequent input data; and updating, based at least on a combination including a subsequent change in configuration values and a subsequent change in inferencing the subsequent input data, the configuration value of the configuration setting for further operating the IoT device.

In still further aspects, the technology relates to an Internet-of-Things (IoT) device of a plurality of IoT devices in edge computing connected to an edge server. The IoT device comprises a memory; and a first processor configured to execute a method comprising: receiving, based on a configuration value associated with a configuration setting of the IoT device, input data; determining, by the first processor, a first gradient value, wherein the first gradient value represents a change of the input data from previously received input data based on a change in the configuration setting for capturing content using the IoT device; causing the edge server to determine, using a neural network by a second processor, a second gradient value, wherein the second gradient value indicates a change of inference data based on the change in the input data, wherein the first processor and the second processor are distinct; updating, based at least on a combination of the first gradient value and the second gradient value, the configuration value associated with the configuration setting for adjusting an input operation of the IoT device, wherein the combination of the first gradient value and the second gradient value represents an anticipated change of the inference data over a change in the configuration value associated with the configuration setting of the IoT device, and wherein the updating results in improving inferencing of the input data by adjusting the configuration setting of the IoT device; and receiving, based on the updated configuration value using the IoT device, subsequent input data. The second processor includes a graphical processing unit associated with a data analytic pipeline of a Multi-access Edge Computing in a 5G telecommunication network, and wherein the second processor is distinct from the first processor. The first gradient value includes an input-configuration gradient, wherein the input-configuration gradient indicates a degree of change in the input data based on updating the configuration value. The second gradient value includes an inference-input gradient, wherein the inference-input gradient indicates a degree of change in confidence scores associated with inferencing the input data as the input data changes, and wherein the inference-input gradient is based on a saliency associated with the neural network. The combination of the first gradient value and the second gradient value represents an inference-configuration gradient, wherein the inference-configuration gradient indicates a degree of change in confidence scores associated with inferencing the input data based on updating the configuration value changes. The configuration value is associated with an image resolution for capturing content using the IoT device.

Any of the one or more above aspects in combination with any other of the one or more aspect. Any of the one or more aspects as described herein.

What is claimed is:

1. What is claimed is:
A method for updating configuration setting associated with capturing content using an Internet-of-Things (IoT) device, including a first processor, of a plurality of IoT devices as at least a part of edge computing system, the method comprising:
receiving, based on a configuration value associated with a configuration setting of the IoT device, input data;
determining, by the first processor, a first gradient value, wherein the first gradient value represents a change of the input data from previously received input data based on a change in the configuration setting for capturing content using the IoT device;
causing an edge server of the edge computing system to determine, using a neural network by a second processor, a second gradient value, wherein the second gradient value indicates a change of inference data based on the change of the input data, wherein the first processor and the second processor are distinct;
updating, based at least on a combination of the first gradient value and the second gradient value, the configuration value associated with the configuration setting for adjusting an input operation of the IoT device, wherein the combination of the first gradient value and the second gradient value represents an anticipated change of inference data over a change in the configuration value associated with the configuration setting of the IoT device, and wherein the updating results in improving inferencing of the input data by adjusting the configuration setting of the IoT device; and
receiving, based on the updated configuration value using the IoT device, subsequent input data.

2. The method according to claim 1, wherein the second processor includes a graphical processing unit associated with a data analytic pipeline of a Multi-access Edge Computing in a 5G telecommunication network, and wherein the second processor is distinct from the first processor.

3. The method according to claim 1, wherein the first gradient value includes an input-configuration gradient, wherein the input-configuration gradient indicates a degree of change in the input data based on updating the configuration value.

4. The method according to claim 1, wherein the second gradient value includes an inference-input gradient, wherein the inference-input gradient indicates a degree of change in confidence scores associated with inferencing the input data as the input data changes, and wherein the inference-input gradient is based on a saliency associated with the neural network.

5. The method according to claim 1, wherein the combination of the first gradient value and the second gradient value represents an inference-configuration gradient, wherein the inference-configuration gradient indicates a degree of change in confidence scores associated with inferencing the input data based on updating the configuration value.

6. The method according to claim 1, wherein the configuration value is associated with an image resolution for capturing content by the IoT device.

7. The method according to claim 1, further comprising:
receiving, based on the updated configuration value associated with the configuration setting for operating the IoT device, the subsequent input data; and
updating, based at least on a combination including a subsequent change in configuration values and a subsequent change in inferencing the subsequent input data, the configuration value of the configuration setting for further operating the IoT device.

8. A system for capturing content using an Internet-of-Things (IoT) device, including a first processor, of a plurality of IoT devices in an edge computing system, the system comprising:
a memory; and
the first processor configured to execute a method comprising:
receiving, based on a configuration value associated with a configuration setting of the IoT device for capturing content, input data;
determining, by the first processor, a first gradient value, wherein the first gradient value represents a change of the input data from previously received input data based on a change in the configuration setting for capturing content using the IoT device;
causing an edge server of the edge computing system to determine, using a neural network by a second processor, a second gradient value, wherein the second gradient value indicates a change of inference data from previously generated inference data based on the change of the input data, wherein the first processor and the second processor are distinct;
updating, based at least on a combination of the first gradient value and the second gradient value, the configuration value associated with the configuration setting for adjusting an input operation of the IoT device, wherein the combination of the first gradient value and the second gradient value represents an anticipated change of the inference data over a change in the configuration value associated with the configuration setting of the IoT device, and wherein the updating results in improving inferencing of the input data by adjusting the configuration setting of the IoT device; and
receiving, based on the updated configuration value using the IoT device, subsequent input data.

9. The system of claim 8, wherein the second processor includes a graphical processing unit associated with a data analytic pipeline of a Multi-access Edge Computing in a 5G telecommunication network, and wherein the second processor is distinct from the first processor.

10. The system of claim 8, wherein the first gradient value includes an input-configuration gradient, wherein the input-configuration gradient indicates a degree of change in the input data based on updating the configuration value changes.

11. The system of claim 8, wherein the second gradient value includes an inference-input gradient, wherein the inference-input gradient indicates a degree of change in confidence scores associated with inferencing the input data as the input data changes, and wherein the inference-input gradient is based on a saliency associated with the neural network.

12. The system of claim 8, wherein the combination of the first gradient value and the second gradient value represents an inference-configuration gradient for adjusting the configuration value of the configuration setting for input operation of the IoT device, wherein the inference-configuration gradient indicates a degree of change in confidence scores associated with inferencing the input data based on updating the configuration value changes.

13. The system of claim 8, wherein the configuration value is associated with an image resolution for capturing content.

14. The system of claim 8, the first processor further configured to execute a method comprising:
receiving, based on the updated configuration value associated with the configuration setting for operating the IoT device, the subsequent input data; and
updating, based at least on a combination including a subsequent change in configuration values and a subsequent change in inferencing the subsequent input data, the configuration value of the configuration setting for further operating the IoT device.

15. An Internet-of-Things (IoT) device of a plurality of IoT devices in edge computing connected to an edge server, the IoT device comprising:
a memory; and
a first processor configured to execute a method comprising:
receiving, based on a configuration value associated with a configuration setting of the IoT device, input data;
determining, by the first processor, a first gradient value, wherein the first gradient value represents a change of the input data from previously received input data based on a change in the configuration setting for capturing content using the IoT device;
causing the edge server to determine, using a neural network by a second processor, a second gradient value, wherein the second gradient value indicates a change of inference data based on the change in the input data, wherein the first processor and the second processor are distinct;
updating, based at least on a combination of the first gradient value and the second gradient value, the configuration value associated with the configuration setting for adjusting an input operation of the IoT device, wherein the combination of the first gradient value and the second gradient value represents an anticipated change of inference data over a change in the configuration value associated with the configuration setting of the IoT device, and wherein the updating results in improving inferencing of the input data by adjusting the configuration setting of the IoT device; and
receiving, based on the updated configuration value using the IoT device, subsequent input data.

16. The IoT device of claim 15, wherein the second processor includes a graphical processing unit associated with a data analytic pipeline of a Multi-access Edge Computing in a 5G telecommunication network, and wherein the second processor is distinct from the first processor.

17. The IoT device of claim 15, wherein the first gradient value includes an input-configuration gradient, wherein the input-configuration gradient indicates a degree of change in the input data based on updating the configuration value.

18. The IoT device of claim 15, wherein the second gradient value includes an inference-input gradient, wherein the inference-input gradient indicates a degree of change in confidence scores associated with inferencing the input data as the input data changes, and wherein the inference-input gradient is based on a saliency associated with the neural network.

19. The IoT device of claim 15, wherein the combination of the first gradient value and the second gradient value represents an inference-configuration gradient, wherein the inference-configuration gradient indicates a degree of change in confidence scores associated with inferencing the input data based on updating the configuration value changes.

20. The IoT device of claim 15, wherein the configuration value is associated with an image resolution for capturing content using the IoT device.
